(19) United States
(12) Patent Application Publication
(10) Pub. No.: US 2005/0225285 A1
(43) Pub. Date: Oct. 13, 2005

(54) Charging base for batteries of different specifications

(76) Inventor: Chin-Hung Cheng, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/817,935

(22) Filed: Apr. 6, 2004

(51) Int. Cl. H02J 7/02

(52) U.S. Cl. 320/111

(57) ABSTRACT

A universal charging base for batteries of different specifications has a body on which a concavity and space that lengthwise communicates with the concavity are defined. A plurality of conductive terminals for electrically contacting the batteries to be charged is disposed near one side of the concavity. Further, protrusions as well as hooks are formed on the body for securing the batteries to be charged on the body. When in use, the batteries of different specifications to be charged are able to be selectively retained in the concavity or the concavity together with the space.

### BACKGROUND OF THE INVENTION

1. Field of the Invention

The present invention relates to a charging base, and more particularly to a universal charging base adaptable to batteries of different specifications.

2. Description of Related Art

As shown by statistics relating to the growth of the cellular phone market, many people possess more than one mobile phone. Similar to other electrical portable devices, the electricity supply of the mobile phone is provided by a chargeable battery. Either the charging base or the charging cable is the commonest means to be operated with the mobile phone. When in use, the charging base allows the mobile phone to be electrically disposed thereon to proceed electricity charging. In another aspect, the charging cable equipped with a power converter is directly connected to a jack of the mobile phone and is very suitable for carrying. However, for a user having multiple mobile phones, preparing different charging bases to respectively correspond to these mobile phones is quite inconvenient. To overcome the problem, a conventional universal charging base as shown in FIGS. 9 and 10 is presented to adapt to different batteries.

Each of the two embodiments in FIGS. 9 and 10 has a body defined with a concavity to retain the battery. To match batteries of different specifications, variety optional accessories (100) are required to be mounted on the concavity thereby allowing batteries to be securely retained in the base. However, when in practical application, these complex accessories are still inconvenient for users.

To solve the foregoing drawback, a novel charging base in accordance with the present invention is proposed.

### SUMMARY OF THE INVENTION

The objective of the present invention is to provide a universal charging base that is adaptable to batteries of different specifications without any need for optional accessories to be fitted on the charging base.

To accomplish the objective, the charging base is formed by:

a body having a top surface on which a concavity is defined by a back as well as two arms that respectively extend from opposite edges of the back, wherein a roof extending from the back further connects between the two arms thus defining a space to lengthwise communicate with the concavity;

a U-shaped flange mounted on the bottom of the concavity and adjacent two opposite inner sidewalls of the two arms, wherein a breach of the U-shaped flange faces toward to the back;

a plurality of conductive terminals disposed near one side of the concavity opposite to the U-shaped flange and protruding upward from the concavity; and

a protrusion as well as a hook formed on each of the two arms for securing the batteries to be charged on the body;

wherein the batteries of different specifications to be charged are able to be selectively retained in the concavity or the concavity together with the space.

Other features of the invention will become apparent from the detailed description when taken in conjunction with the attached drawings.

### BRIEF DESCRIPTION OF THE DRAWINGS

FIG. 1 is a perspective view of a charging base of the present invention;

FIG. 2 is another perspective view of the charging base of the present invention;

FIGS. 3A and 3B are operational views showing one kind of battery is retained in the charging base of the present invention;

FIG. 4A and 4B are operational views showing another kind of battery is retained in the charging base of the present invention;

FIG. 5 is an operational view showing yet another kind of battery is retained in the charging base of the present invention;

FIG. 6 is an operational view showing still yet another kind of battery is retained in the charging base of the present invention;

FIG. 7 is an operational view showing still yet another kind of battery is retained in the charging base of the present invention;

FIGS. 8A and 8B show yet another kind of battery is assembled in the charging base of the present invention; and

FIGS. 9 and 10 are exploded perspective views of conventional battery charging bases.

### DETAILED DESCRIPTION OF THE PREFERRED EMBODIMENT

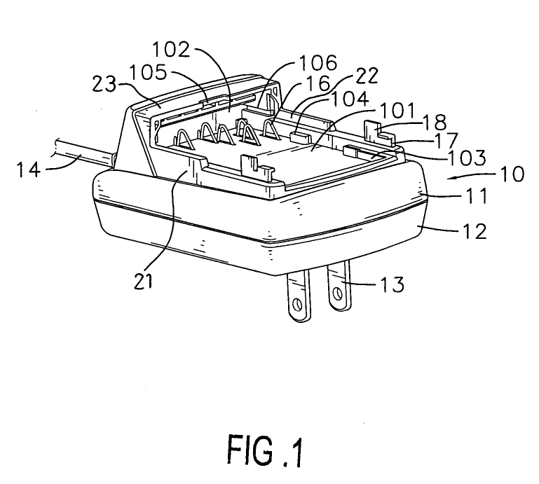

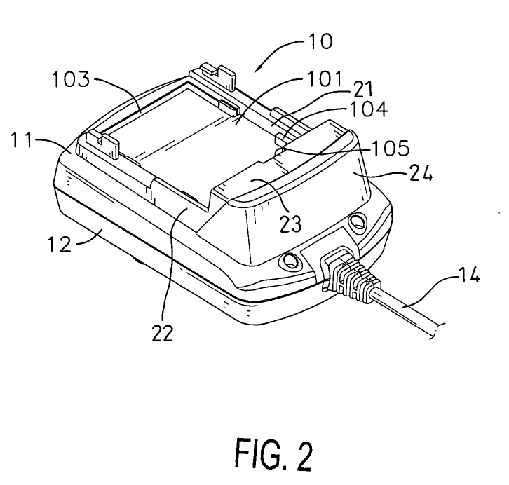

With reference to FIG. 1, a charging base (10) in accordance with the present invention is consisted of a body including an upper case (11) correspondingly assembled on a lower case (12) thus defining a chamber. A charging circuit (not shown) for converting AC power to DC power is mounted in the chamber, wherein input terminals of the charging circuit are electrically connected to a plug (13) that extends from the lower case (12) downward for inserting into an AC power outlet (not shown). A power wire (14) has one end connected to output terminals of said charging circuit to derive DC power, and the other end is formed with a connector (not shown) to electrically connect to a mobile phone for electricity charge.

Moreover, a battery to be charged is allowed to directly attach on the charging base (10) to electrically contact with conductive terminals of the base (10). A back (24) extending upward from the upper case (11) has a top edge from which a roof (23) horizontally extends out. Two arms (21)(22) are respectively and integrally connected at opposite edges of the roof (23), whereby a non-closed concavity (101) is defined among the back (24) and the two arms (21)(22). Each arm (21) (22) is substantially step shaped with one end higher than the other end, wherein the highest end of each arm (21)(22) is connected to the edge of the roof (23) while the other end extends toward a direction opposite to the back (24). Further, a space (102), beneath the roof (23), is defined by the roof (23) as well as the highest ends of the two arms (21)(22).

A U-shaped flange (103) with a breach is mounted on the bottom of the concavity (101) and adjacent inner sidewalls of the two arms (21)(22), wherein the breach of the U-shaped flange (13) faces toward to the rear of the back (24). Two independent blocks (104) are respectively formed on the concavity (101) and adjacent the inner walls of the two arms (21)(22). Both the blocks (104) and the U-shaped flange (103) have the same heights and widths.

A plurality of conductive terminals (16) is disposed near one side of the concavity (101) opposite to the U-shaped block (103) and protrudes upward from the bottom of the concavity (101) to touch the charging contacts of a battery. The plurality of conductive terminals (16) also electrically connects to the output terminals of the charging circuit. It is noted that each terminal (16) is able to be slightly pressed downward when a battery is placed on the terminal (16), and returns to its original status when the battery is removed.

A notch (105) is further defined at a middle portion of one edge of the roof (23). Two grooves (106) are respectively defined in opposite inner sidewalls of the roof (23). A protrusion (18) and a hook (17) are formed on each of the two arms (21)(22).

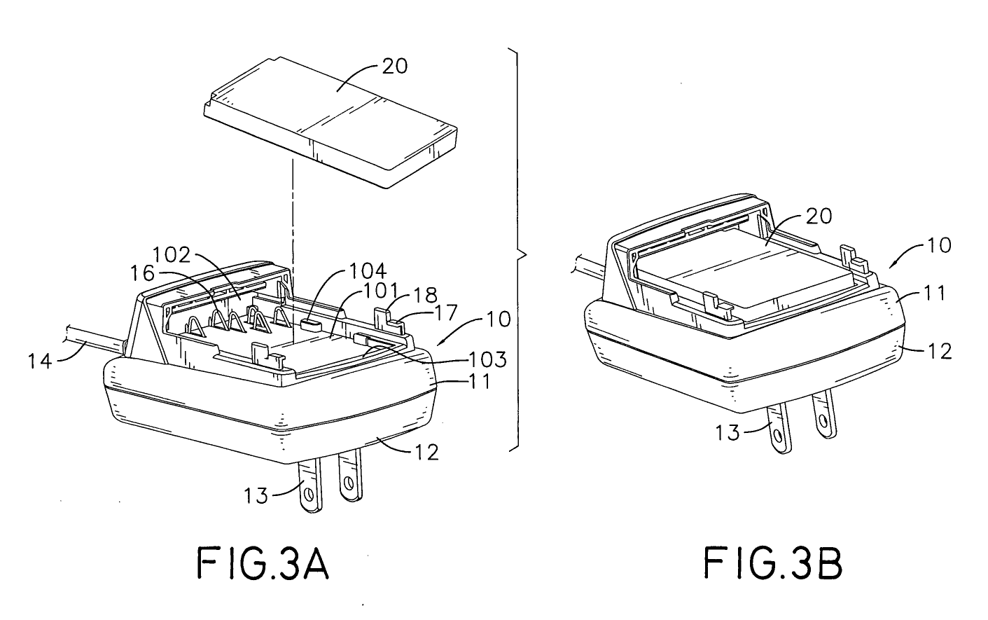

With reference to FIGS. 3A and 3B, one kind of flat battery (20) is completely retained in the concavity (101), wherein a rear side of the battery (20) is tightly abutted by the U-shaped flange (103). When the battery (20) is mounted on the charging base (10), charging contacts (not shown) formed on the bottom of the battery (20) are correspondingly in touch with the plurality of conductive terminals (16). Therefore, the charging circuit is able to proceed charging to the battery (20) through the terminals (16).

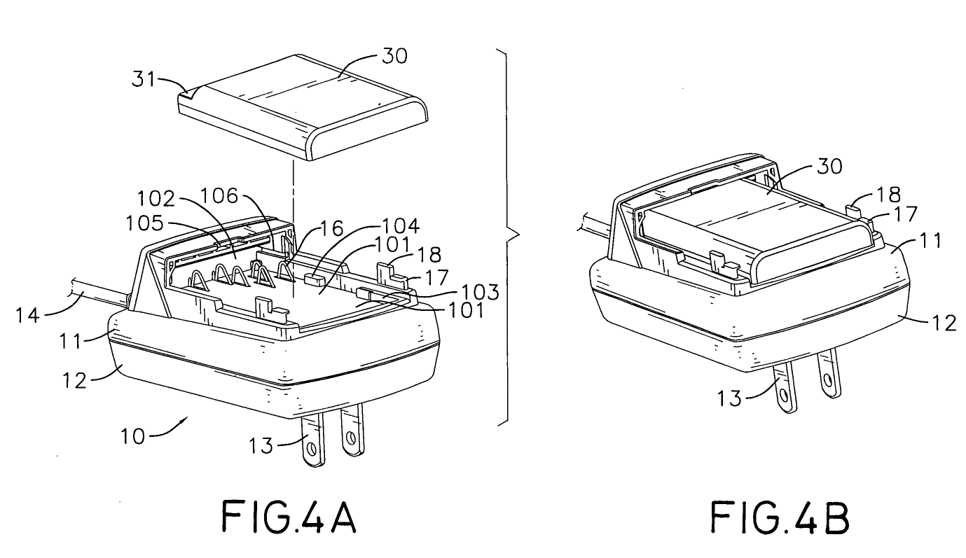

With reference to FIGS. 4A and 4B, another kind of flat battery (30), which is slightly thicker and longer than the previous battery (20), has a front end (31) thinner than the body of the battery (30). When placing the battery (30) on the charging base (10), the thinner front end (31) is just received in the space (102). The bottom surface of the battery (30) is supported by the two blocks (104) and the U-shaped flange (103). Similarly, charging contacts (not shown) formed on the bottom of the battery (30) are correspondingly in touch with the plurality of conductive terminals (16).

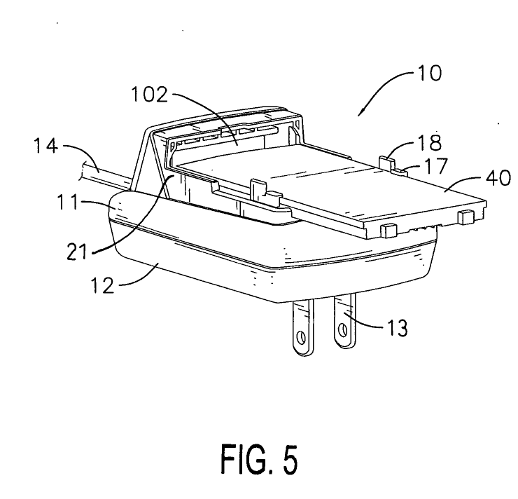

With reference to FIG. 5, when a thin flat battery (40) with a size longer than the concavity (101) is intended to be charged, the front end of the battery (40) is retained in the space (102) and is supported by the U-shaped flange (103) and the two blocks (104). Furthermore, each of the two hooks (17) standing on the two arms (21)(22) engages with the opposing edges of the battery (40). The charging contacts (not shown) formed on the bottom of the battery (40) are also correspondingly in touch with the plurality of conductive terminals (16).

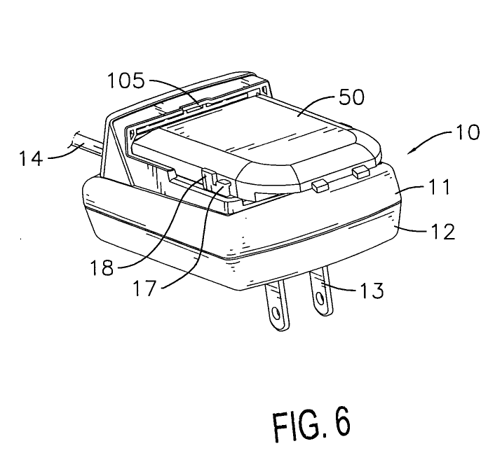

With reference to FIG. 6, another type of the battery (50) having a greater thickness is retained on the charging base by the opposite protrusions (18). The front end of the battery (50) is completely received in the space (102).

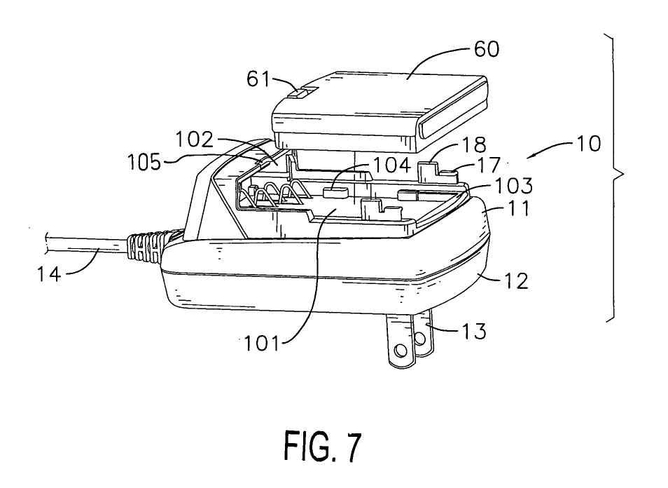

With reference to FIG. 7, a battery (60) with an elastic buckle (61) formed thereon is retained in the concavity (101), wherein the elastic buckle (61) correspondingly engages with the notch (105). It is noted that the front portion of the battery (60) is not in the space (102).

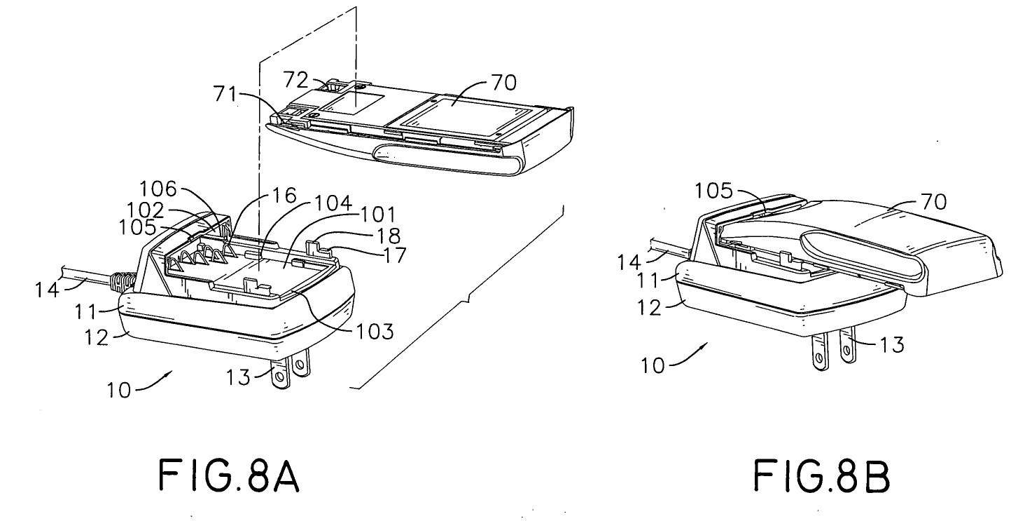

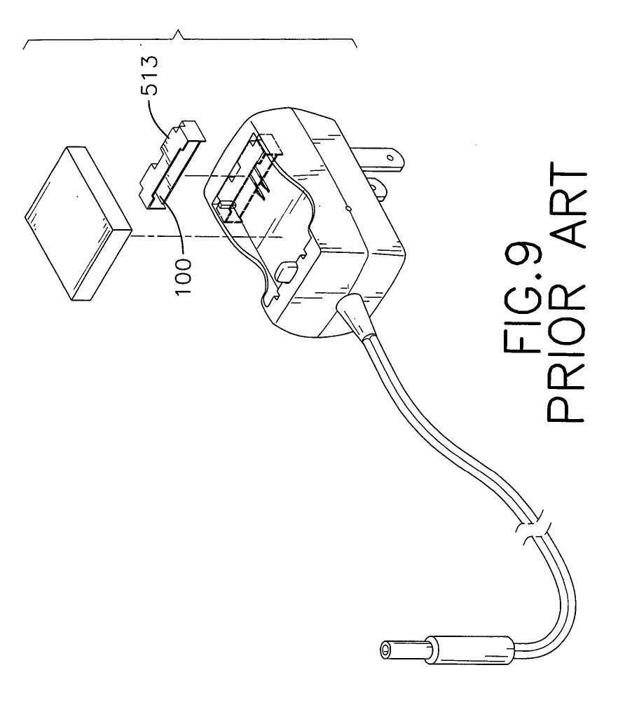

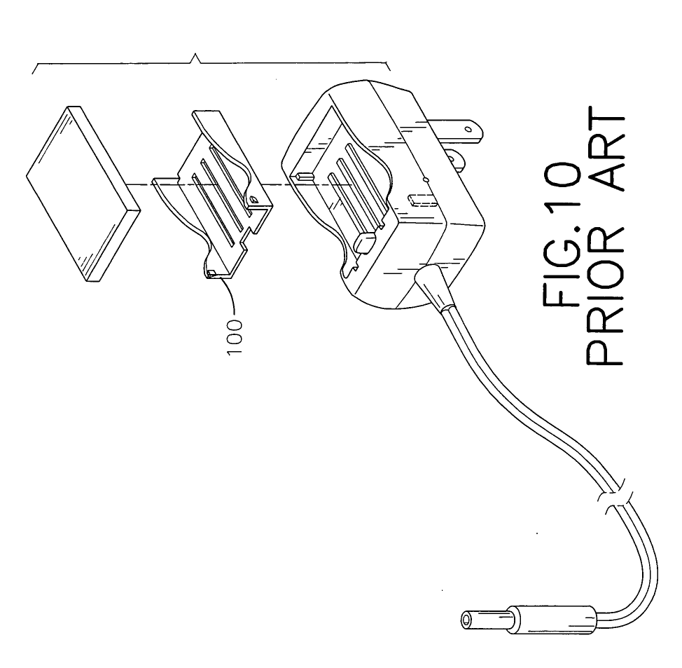

With reference to FIGS. 8A and 8B, a mobile phone battery (70) has two plates (71) respectively formed at opposite sides of the battery (70). When the battery (70) is retained in the concavity (101), its front end is received in the space (102) and the two plates (71) are guided into the grooves (106) thereby securing the battery (70) to the base (10). The charging contacts (72) formed on the bottom of the battery (70) are also correspondingly in touch with the plurality of conductive terminals (16).

The present invention is not limited to the specially disclosed embodiments and variations, and modifications may be made without departing from the scope and spirit of the invention.

1. A charging base for batteries of different specifications, the charging base comprising:
a body having a top surface on which a concavity (101) is defined by a back (24) and two arms (21,22) that respectively extend from opposite edges of the back (24), wherein a roof (23) extending from the back (24) further connects between the two arms (21, 22) thus defining a space (102) to lengthwise communicate with the concavity (101);
a U-shaped flange (103) mounted on the bottom of the concavity (101) and adjacent two opposite inner sidewalls of the two arms (21)(22), wherein a breach of the U-shaped flange (13) faces toward to the back (24);
a plurality of conductive terminals (16) disposed near one side of the concavity (101) opposite to the U-shaped flange (103) and protruding upward from the concavity (101) to electrically contact the batteries to be charged; and
a protrusion (18) and a hook (17) formed on each of the two arms (21)(22) for securing the batteries to be charged on the body;
wherein the batteries of different specifications to be charged are able to be selectively retained in the concavity or the concavity together with the space.

2. The charging base as claimed in claim 1, wherein two grooves (106) are respectively defined in the opposite inner sidewalls of the two arms (21)(22).

3. The charging base as claimed in claim 1, wherein the body is formed by an upper case (11) correspondingly assembled on a lower case (12) thus defining a chamber, wherein a notch (105) is defined at one edge of the roof (23).

4. The charging base as claimed in claim 2, wherein the body is formed by an upper case (11) correspondingly assembled on a lower case (12) thus defining a chamber, wherein a notch (105) is defined at one edge of the roof (23).

5. The charging base as claimed in claim 3, wherein a charging circuit is mounted in the chamber and a plug (13) protruding from the body is electrically connected to the charging circuit, wherein the charging circuit further electrically connects to the plurality of conductive terminals.

6. The charging base as claimed in claim 4, wherein a charging circuit is mounted in the chamber and a plug (13) protruding from the body is electrically connected to the charging circuit, wherein the charging circuit further electrically connects to the plurality of conductive terminals.

7. The charging circuit as claimed in claim 5, wherein a power wire (14) has a first end connected to the charging circuit and a second end to electrically adapted to connect to a mobile phone to be charged.

8. The charging circuit as claimed in claim 6, wherein a power wire (14) has a first end connected to the charging circuit and a second end to electrically adapted to connect to a mobile phone to be charged.

9. The charging circuit as claimed in claim 7, wherein two blocks (104) are formed on the concavity (101) and respectively adjacent the two arms (21)(22), wherein both the blocks (104) and the U-shaped flange (103) have the same height.

10. The charging circuit as claimed in claim 8, wherein two blocks (104) are formed on the concavity (101) and respectively adjacent the two arms (21)(22), wherein both the blocks (104) and the U-shaped flange (103) have the same height.
